(19) United States
(12) Patent Application Publication
(10) Pub. No.: US 2015/0313093 A1
(43) Pub. Date: Nov. 5, 2015

(54) HYDROPONIC PACKAGING SYSTEM AND METHODS

(71) Applicant: VFT Global, LLC, New York, NY (US)

(72) Inventor: Robert J. Brot, New York, NY (US)

(21) Appl. No.: 14/701,206

(22) Filed: Apr. 30, 2015

Related U.S. Application Data
(60) Provisional application No. 61/988,072, filed on May 2, 2014.

(51) Int. Cl. A01G 7/06; B65B 31/00; B65D 59/04; B65D 85/52; B65D 43/02

(52) U.S. Cl. CPC A01G 7/06; B65D 85/52; B65D 43/02; B65D 59/04; B65B 31/006

(57) ABSTRACT

Packaging systems for hydroponically grown plants and method of use thereof. The packaging and process helps preserve the freshness of the plant and allows for added shelf life to the plants after harvesting.

### PRIORITY DATA

This patent application is a non-provisional patent application claiming priority to U.S. Provisional Patent Application No. 61/988,072, filed on May 2, 2014, the entirety of which is incorporated herein by reference.

### FIELD

The present invention relates to packaging systems for hydroponically grown plants and methods of use thereof. The packaging and process helps preserve the freshness of the plant and allows for added shelf life to the plants after harvesting.

### BACKGROUND

Traditionally, cultivation of produce, such as lettuce, that is grown in the open field is packaged without its roots, which are cut off during the harvest. An alternative way to grow produce is to grow it hydroponically. Because of this different growing methodology, produce can be harvested with roots still attached. In the past, some hydroponic growers have cut off the roots and packaged the produce similar to the procedure for open field produce. Other growers have left the roots on and packaged the produce in plastic clamshells.

### SUMMARY

In various embodiments, the present invention provides novel packaging and packaging processes that increases shelf life of hydroponically grown produce, in particular leafy greens.

In one embodiment, the invention provides a packaging system for packaging hydroponically grown produce, the packaging system comprising a packaging sleeve 100 and a closure device 301. In one embodiment, the invention provides a produce package, comprising: a flexible packaging sleeve 100 comprising an open top end 101 and a closed bottom end 102, said closed bottom end capable of retaining water and substantially shaped for receiving a root ball of a plant; and a closure device 301 suitable for constricting the sleeve at a point between the top and bottom ends to allow the root ball to remain substantially in contact with water present in the bottom end.

In one embodiment, the invention provides a packaging system wherein the packaging sleeve 100 comprises an open top end 101 and a closed bottom end 102.

In one embodiment, the invention provides a packaging system for hydroponically grown produce wherein the packaging system comprises a packaging sleeve 100, a closed bottom 801, and an optional lid 701.

In one embodiment, the invention provides a method for packaging hydroponically grown produce, the method comprising the steps of: adding an amount of liquid to a packaging sleeve 100, the packaging sleeve 100 having a top and a bottom; introducing at least one hydroponically grown produce 303, with roots 302 attached, into the packaging sleeve 100 so that the roots 302 are substantially toward the bottom of the packaging sleeve 100; and banding or otherwise closing the packaging sleeve 100 with a closure device 301 to reduce the risk of the liquid escaping therefrom.

In another embodiment, the invention provides a method for packaging hydroponically grown produce, the method including the steps of: introducing at least one hydroponically grown produce 303, with roots 302 attached, into the packaging sleeve 100 so that the roots 302 are substantially toward the bottom of the packaging sleeve 100; adding an amount of a liquid to the packaging sleeve 100; and banding or otherwise closing the packaging sleeve 100 with a closure device 301 to reduce the risk of the liquid escaping therefrom.

In some embodiments, methods of the invention comprise covering or submersing the roots 302 substantially with a liquid, for example, water. In some embodiments, the liquid comprises an amount of at least one fertilizer, nutrient, mineral, or combinations thereof.

In some embodiments, the methods of the invention comprise banding the packaging sleeve 100 with a closure device 301 just above the roots 302 to create a bulb at a base of the hydroponically grown produce 303.

In some embodiments, methods of the invention comprise a packaging sleeve 100 that covers substantially the entire hydroponically grown produce 303. In some embodiments, methods of the invention comprise a packaging sleeve 100 that covers substantially the roots 302 only. In some embodiments, at least an amount of the packaging sleeve 100 is flexible. In some embodiments the packaging sleeve 100 is made of a substantially inflexible material. In some embodiments, at least an amount of the packaging sleeve 100 is transparent. In some embodiments, at least an amount of the packaging sleeve 100 is printed with branding 103, nutritional information 201 and/or other product information. In some embodiments the packaging system includes a closed bottom 801. In some embodiments the closed bottom 801 is removable. In some embodiments the packaging system includes a lid 701. In some embodiments the lid 701 is removable.

The produce suitable for use in various embodiments of the invention comprise at least one hydroponically grown produce 303. In some embodiments, the produce is selected from arugula, kale, lettuce, mustard greens, spinach, Swiss chard, watercress, and other similar produce.

In yet other embodiments, methods of the invention further comprise the step of replenishing the liquid in the packaging sleeve 100.

These and other embodiments of the present invention will be disclosed in further detail herein below.

### BRIEF DESCRIPTION OF THE FIGURES

FIG. 1 shows an exemplary embodiment of a front view of a packaging sleeve 100. The packaging sleeve 100 having an open top 101 and a closed bottom end 102. The packaging sleeve 100 may also be printed with branding 103.

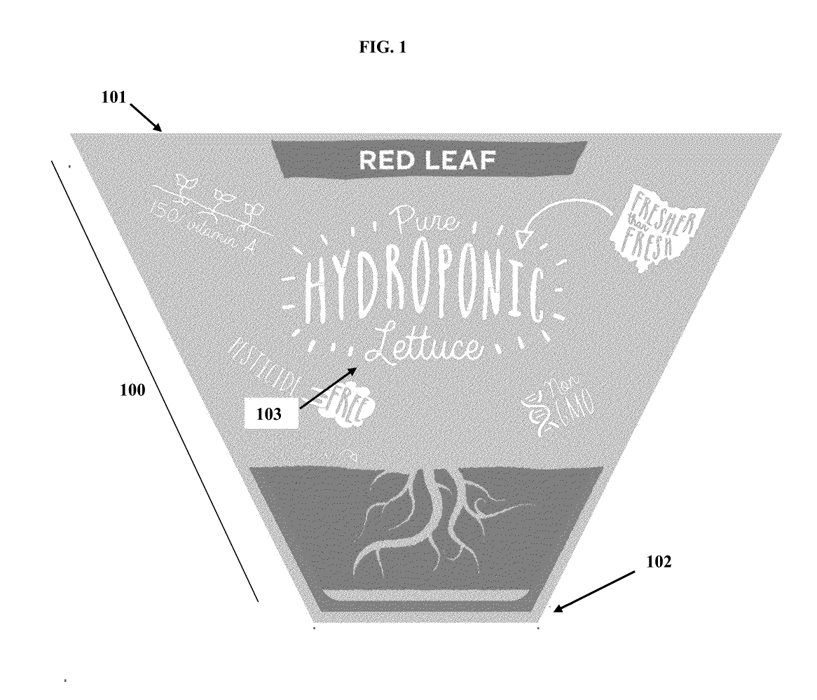

FIG. 2 shows an exemplary embodiment of a back view of a packaging sleeve 100. The packaging sleeve 100 having an open top 101 and a closed bottom end 102. The packaging sleeve 100 may also be printed with branding 103 and nutritional information 201.

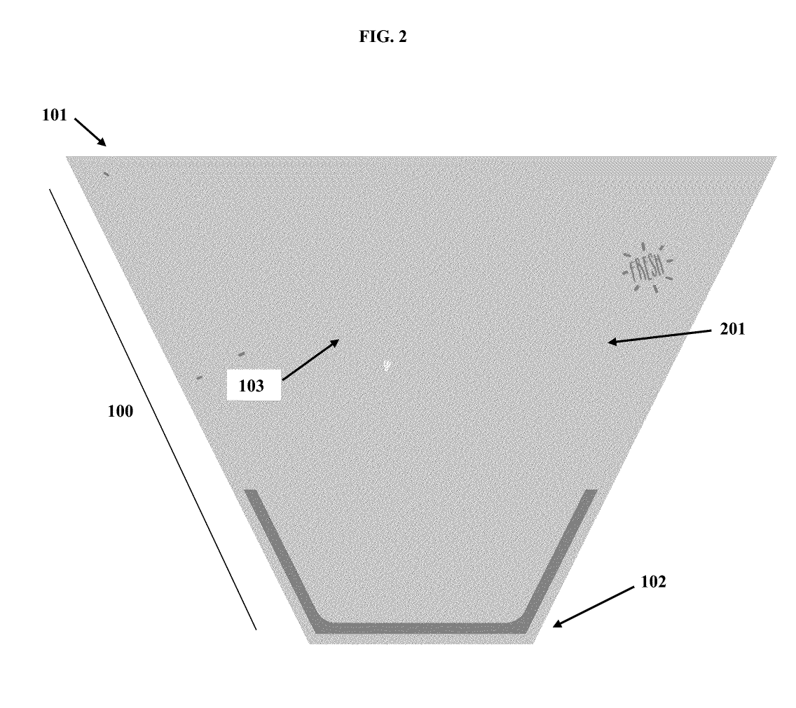

FIG. 3 shows an exemplary embodiment of a packaging sleeve 100 containing a hydroponically grown produce 303. The packaging sleeve 100 having an open top 101 and a closed bottom end 102. The packaging sleeve 100 is banded just above the roots 302 with a closure device 301 to create a bulb at base of the hydroponically grown produce 303.

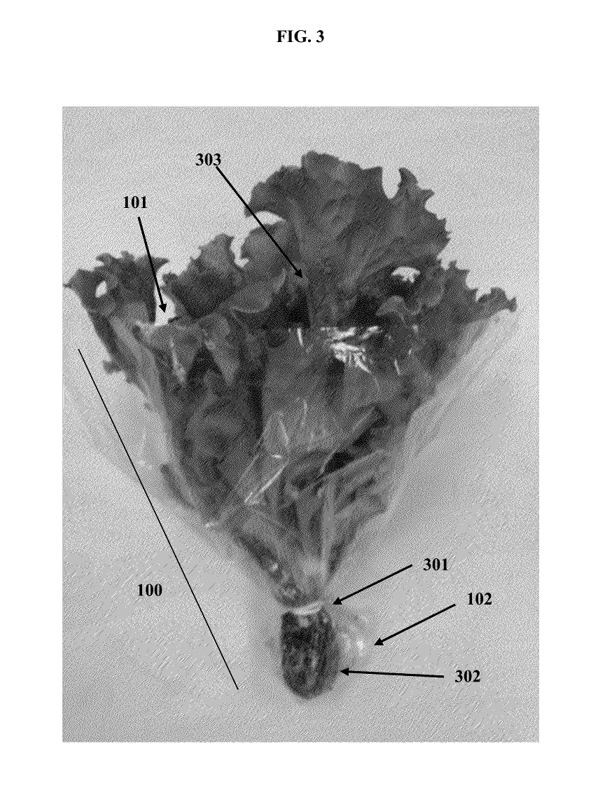

FIG. 4 shows another exemplary embodiment of a packaging sleeve 100 containing a hydroponically grown produce 303. The packaging sleeve 100 having an open top 101 and a closed bottom end 102. The packaging sleeve 100 is banded just above the roots 302 with a closure device 301 to create a bulb at base of the hydroponically grown produce 303.

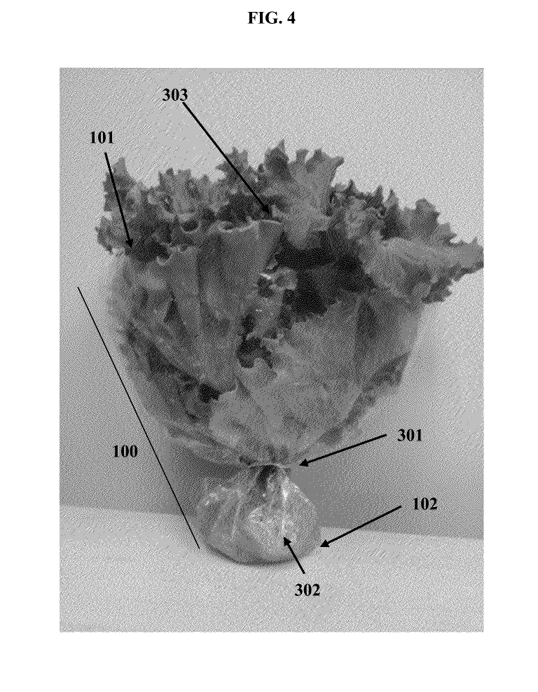

FIG. 5 shows yet another exemplary embodiment of a packaging sleeve 100 containing a hydroponically grown produce 303. The packaging sleeve 100 having an open top 101 and a closed bottom end 102. The packaging sleeve 100 is banded just above the roots 302 with a closure device 301 to create a bulb at base of the hydroponically grown produce 303.

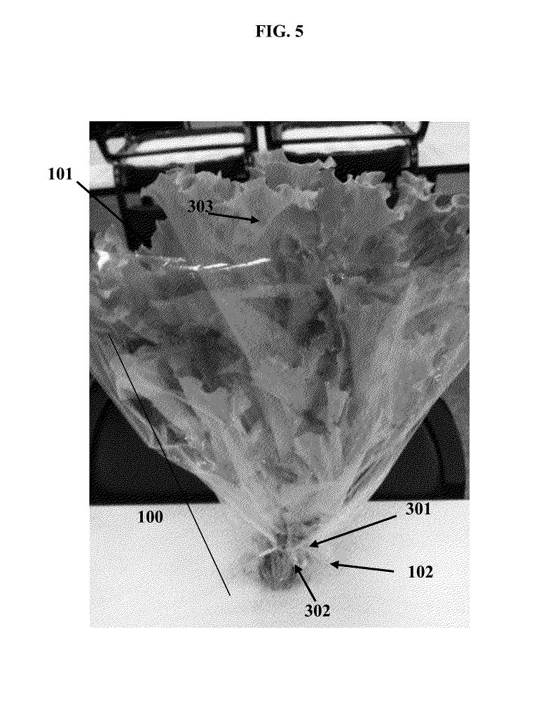

FIG. 6 shows an exemplary embodiment of a hydroponically grown produce 303. The roots 302 of the hydroponically grown produce 303 may be balled-up before introducing the hydroponically grown produce 303 into a packaging sleeve.

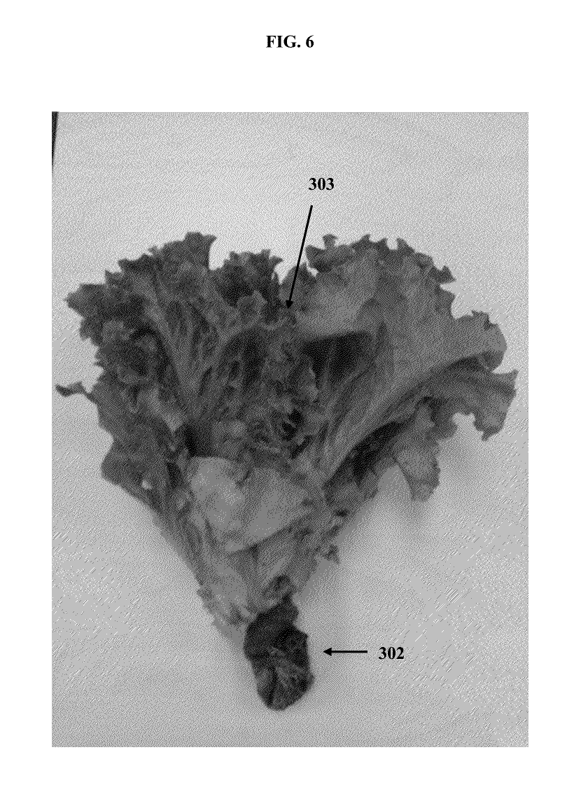

FIG. 7 shows another exemplary embodiment of a packaging sleeve 100. The packaging sleeve 100 having on the top end a removable lid 701. The packaging sleeve 100 may also be printed with branding 103.

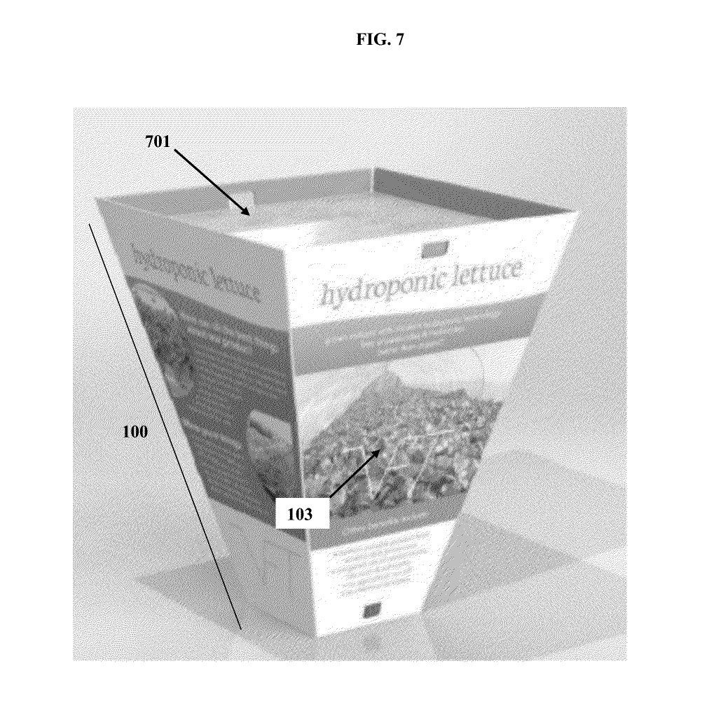

FIG. 8 shows an exploded view of an exemplary embodiment. The packaging sleeve 100 mounts to a bottom 801 and the top end of the packaging sleeve 100 may have a removable lid 701. The packaging sleeve 100 may also be printed with branding 103.

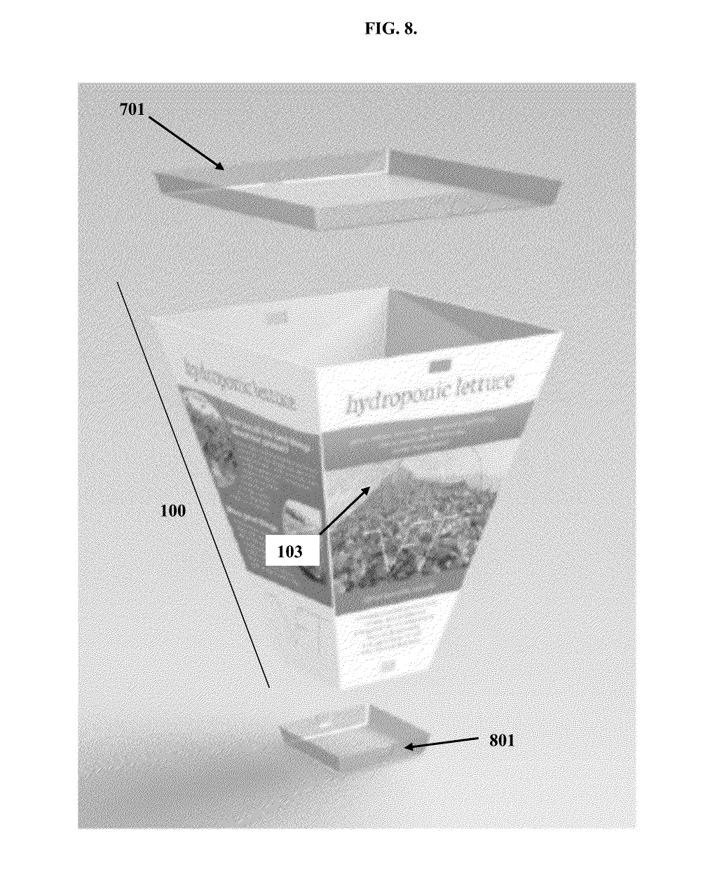

FIG. 9 shows another exemplary embodiment of a front view of packaging sleeve 100 containing a hydroponically grown produce 303. The packaging sleeve 100 having an open top 101 and a closed bottom end 102. The packaging sleeve 100 may also be printed with branding 103.

FIG. 10 shows another exemplary embodiment of a front view of packaging sleeve 100 containing a hydroponically grown produce 303. The packaging sleeve 100 having an open top 101 and a closed bottom end 102. The packaging sleeve 100 may also be printed with branding 103.

### DETAILED DESCRIPTION

While the present invention is capable of being embodied in various forms, the description below of several embodiments is made with the understanding that the present disclosure is to be considered as an exemplification of the invention, and is not intended to limit the invention to the specific embodiments illustrated. Headings are provided for convenience only and are not to be construed to limit the invention in any manner. Embodiments illustrated under any heading may be combined with embodiments illustrated under any other heading.

The use of numerical values in the various quantitative values specified in this application, unless expressly indicated otherwise, are stated as approximations as though the minimum and maximum values within the stated ranges were both preceded by the word “about.” Also, the disclosure of ranges is intended as a continuous range including every value between the minimum and maximum values recited as well as any ranges that can be formed by such values. Also disclosed herein are any and all ratios (and ranges of any such ratios) that can be formed by dividing a disclosed numeric value into any other disclosed numeric value. Accordingly, the skilled person will appreciate that many such ratios, ranges, and ranges of ratios can be unambiguously derived from the numerical values presented herein and in all instances such ratios, ranges, and ranges of ratios represent various embodiments of the present invention.

In one embodiment, the invention provides a packaging system for packaging hydroponically grown produce 303, the packaging system comprising a packaging sleeve 100 and a closure device 301. The term “hydroponically grown produce,” as used herein means plants grown in a water and/or nutrient solution, without soil, allowing the plants to grow in a more efficient and productive manner with less labor and time required. The term “closure device,” as used herein may include a rubber band, twist-tie, string, tape, clip, wire, zip-tie, or among others, or any other device suitable for restricting escape of the liquid form the packaging sleeve, or at least a portion thereof. The packaging sleeve 100 can be the designed to cover just the root ball of the plant, to cover the entirety of the plant, or to cover the root ball and other portions of the plant.

In one embodiment, packaging of the present invention allows for increased packing density for transport and storage. In another embodiment, packaging of the present invention allows for vertical storage and shipping of the produce. In another embodiment, packaging of the present invention reduces or eliminates the need for expensive and space consuming misting equipment on grocery store floors.

In one embodiment, the invention provides a packaging system of wherein the packaging sleeve 100 comprises an open top 101 and a closed bottom end 102. In some embodiments the open top is a substantially open top. One of skill in the art would understand the invention to allow for top that was not completely open, but at least open in an amount to allow for the introduction of at least one hydroponically grown produce 303 into the packaging sleeve 100.

In one embodiment, the invention provides a method for packaging hydroponically grown produce 303, the method comprising the steps of: providing a packaging sleeve 100, substantially as described herein, adding an amount of liquid to the packaging sleeve 100, the packaging sleeve 100 having a top end and a bottom end; introducing at least one hydroponically grown produce 303, with roots 302 attached, into the packaging sleeve 100 so that the roots 302 are substantially toward the bottom end of the packaging sleeve 100; and banding the packaging sleeve 100 with a closure device 301. In one embodiment, the bottom end of the packaging sleeve 100 is at least substantially closed and the top end of the packaging sleeve 100 is at least substantially open.

In another embodiment, the invention provides a method for packaging hydroponically grown produce, the method including the steps of: introducing at least one hydroponically grown produce 303, with roots 302 attached, into a packaging sleeve 100 as described herein so that the roots 302 are substantially toward the bottom end of the packaging sleeve 100; adding an amount of a liquid (e.g. about 1 to about 10, 1 to about 5 or 1 to about 3 ounces) to a packaging sleeve 100; and banding the packaging sleeve 100 with a closure device 301.

In some embodiments, methods of the invention comprise covering the roots 302 substantially with a liquid, for example, water. One of skill in the art would be able to determine the appropriate amount of liquid necessary, taking into account the type of hydroponically grown produce 303, size of the packaging sleeve 100 and placement of the closure device 301, duration of storage and transport, etc. In some embodiments, the liquid comprises an amount of at least one fertilizer, nutrient, mineral, or combinations thereof.

In some embodiments, the methods of the invention comprise banding a root sleeve with a closure device 301 just above the roots 302 to create a bulb at a base of the hydroponically grown produce 303. In some embodiments, the invention provides a packaging system comprising a root sleeve designed to cover just the roots and not the remaining portion of the produce. In such an embodiment, produce bound with a water-filled root sleeve can be packed in any additional packaging (e.g. box, bag, etc.) desired. Such additional packaging can provide protection, display information, etc.

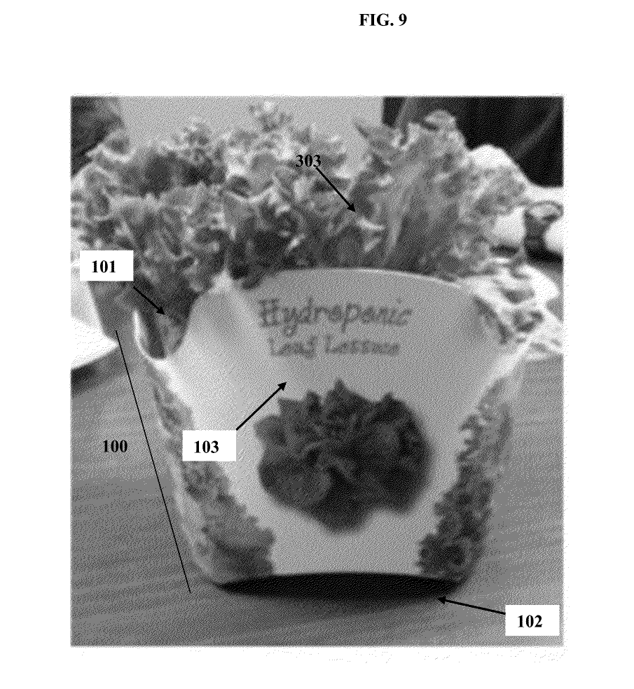

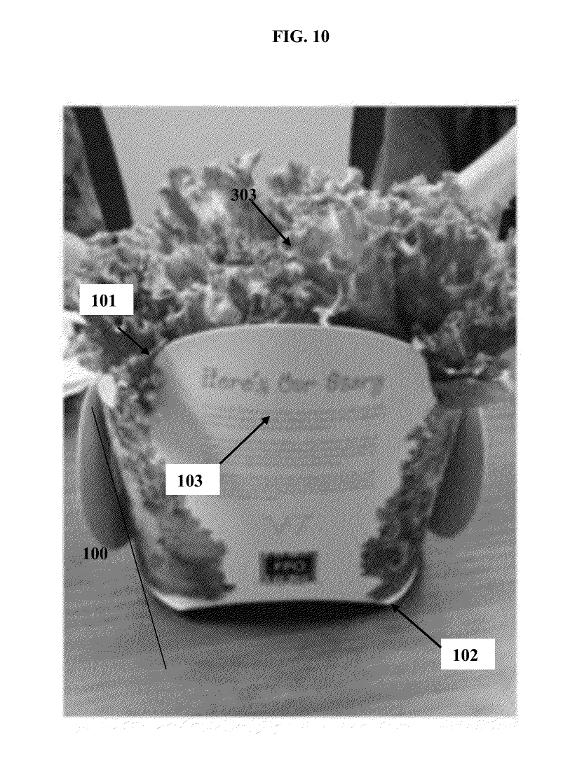

In some embodiments, methods of the invention comprise a packaging sleeve 100 that covers substantially the entire hydroponically grown produce 303. In some embodiments, methods of the invention comprise a packaging sleeve 100 that covers substantially the roots 302 only. In some embodiments, at least an amount of the packaging sleeve 100 is flexible, such as a thin plastic, biodegradable film, among other materials. In some embodiments the packaging sleeve 100 is made of a substantially inflexible material, such as cardboard or a hard plastic, among others. In some embodiments, at least an amount of the packaging sleeve 100 is transparent. In some embodiments, at least an amount of the packaging sleeve 100 is printed with branding 103, nutritional information 201 and/or other product information. In some embodiments, the packaging is printed with design elements (e.g. lettuce artwork or photography) providing an illusion of product extending onto the packaging, for example as shown in FIGS. 9 and 10. In some embodiments the packaging system includes a bottom 801. In some embodiments the bottom 801 is removable. In some embodiments the packaging system includes a lid 701. In some embodiments the lid 701 is removable.

In some embodiments, methods of the invention comprise at least one hydroponically grown produce 303 that is selected from arugula, kale, lettuce, mustard greens, spinach, Swiss chard and watercress, and the like. Types of lettuce may include romaine, arugula, mache, watercress, butter, leaf, mizuna, curly endive, and frisee, among others. One of skill in the art would also appreciate the use of this invention for herbs and micro greens, such as, but not limited to, basil, dark basil, valeriane, radishes, mesclun, chicory, cervil, Chinese cabbage, wild roquette, baby lettuce, green onion, Asian greens, culinary herbs, and medicinal herbs. In one embodiment, the harvested lettuce contains no or substantially no amount of soil associated with the root ball.

In yet other embodiments, methods of the invention further comprise the step of replenishing the liquid in the packaging sleeve 100.

What is claimed is:

1. A packaging system for hydroponically grown produce, the packaging system comprising a packaging sleeve and a closure device.

2. The packaging system of claim 1 wherein the packaging sleeve comprises an open top end and a closed bottom end.

3. A packaging system for hydroponically grown produce, the packaging system comprising a packaging sleeve and a closed bottom.

4. The packaging system of claim 3 wherein the packaging sleeve is composed of a substantially rigid material.

5. The packaging system of claim 3 wherein the closed bottom is removable.

6. The packaging system of claim 3 further comprising a lid.

7. The packaging system of claim 6 wherein the lid is removable.

8. A method for packaging hydroponically grown produce, the method comprising the steps of:
a. adding an amount of liquid to a packaging sleeve, the packaging sleeve having a top and a bottom;
b. introducing at least one hydroponically grown produce, with roots attached, into the packaging sleeve so that the roots are substantially toward the bottom of the packaging sleeve; and
c. banding the packaging sleeve with a closure device.

9. The method of claim 8 wherein the liquid substantially covers the roots.

10. The method of claim 8 wherein the sleeve is banded just above the roots to create a bulb at base of the at least one hydroponically grown produce.

11. The method of claim 8 wherein the liquid comprises water.

12. The method of claim 8 wherein the liquid comprises an amount of at least one fertilizer, nutrient, mineral, or combinations thereof.

13. The method of claim 8 wherein the packaging sleeve covers substantially the entire at least one hydroponically grown produce.

14. The method of claim 8 wherein the packaging sleeve covers substantially the roots only.

15. The method of claim 8 wherein the at least one hydroponically grown produce is selected from arugula, kale, lettuce, mustard greens, spinach, Swiss chard and watercress.

16. The method of claim 8 wherein the at least one hydroponically grown produce is lettuce.

17. The method of claim 8 further comprising the step of replenishing the liquid in the sleeve.

18. A method for packaging hydroponically grown produce, the method including the steps of:
a. introducing at least one hydroponically grown produce, with roots attached, into the packaging sleeve roots so that the roots are substantially toward the bottom of the packaging sleeve;
b. adding an amount of a liquid to the packaging sleeve; and
c. banding the packaging sleeve with a closure device.

19. The method of claim 18 wherein the liquid substantially covers the roots.

20. The method of claim 18 wherein the sleeve is banded just above the roots to create a bulb at base of the at least one hydroponically grown produce.

21. The method of claim 18 wherein the liquid comprises water.

22. The method of claim 18 wherein the liquid comprises an amount of at least one fertilizer, nutrient, mineral, or combinations thereof.

23. The method of claim 18 wherein the packaging sleeve covers substantially the entire at least one hydroponically grown produce.

24. The method of claim 18 wherein the packaging sleeve covers substantially the roots only.

25. The method of claim 18 wherein the at least one hydroponically grown produce is selected from arugula, kale, lettuce, mustard greens, spinach, Swiss chard and watercress.

26. The method of claim 18 wherein the at least one hydroponically grown produce is lettuce.

27. The method of claim 18 further comprising the step of replenishing the liquid in the sleeve.

28. A produce package, comprising: a flexible packaging sleeve comprising an open top end and a closed bottom end, said closed bottom end capable of retaining water and substantially shaped for receiving a root ball of a lettuce plant; and a closure device suitable for constricting the sleeve at a point between the top and bottom ends to allow the root ball to remain in contact with water present in the bottom end.
